(19) United States
(12) Patent Application Publication
(10) Pub. No.: US 2025/0320971 A1
(43) Pub. Date: Oct. 16, 2025

(54) PORTABLE PRESSURE VESSEL APPARATUS

(71) Applicant: YSN Imports, LLC, Commerce, CA (US)

(72) Inventors: Shmuel Dovid Newman, Los Angeles, CA (US); Surasak Urpsirisuk, Bangkok (TH)

(21) Appl. No.: 19/175,608

(22) Filed: Apr. 10, 2025

Related U.S. Application Data
(60) Provisional application No. 63/632,004, filed on Apr. 10, 2024.

(51) Int. Cl. F17C 13/08

(52) U.S. Cl. CPC F17C 13/085; F17C 2201/0109; F17C 2201/058; F17C 2205/0161; F17C 2205/0165; F17C 2205/018; F17C 2205/0323; F17C 2250/0413

(57) ABSTRACT

An exemplary portable pressure vessel apparatus includes a cylinder body, an undercarriage subassembly, and a collar subassembly. The undercarriage subassembly includes a foot portion, one or more wheel mount brackets, two wheels, and a forward tilt stabilizer. The collar subassembly is attached to the top dome of the cylinder body, and includes a collar, one or more rear support feet, and one or more collar brackets. The wheels are removably mountable to respective wheel mount brackets. The forward tilt stabilizer is removably securable to the foot portion. The wheels and the forward tilt stabilizer are configured to stably support the cylinder body on a local horizontal surface in a vertical position when the wheels are mounted and the forward tilt stabilizer is secured. The foot portion is configured to stably support the cylinder body in a vertical position when the forward tilt stabilizer and the wheels are removed.

### RELATED APPLICATIONS

This application claims the benefit of U.S. Provisional Application No. 63/632,004 filed Apr. 10, 2024, the content of which is incorporated by this reference in its entirety for all purposes as if fully set forth herein.

### TECHNICAL FIELD

The present disclosure relates to portable pressure vessels, such as gas cylinders with wheels.

### SUMMARY

Certain deficiencies of the prior art are overcome by the provision of a portable pressure vessel apparatus, as disclosed herein.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a diagrammatic perspective view of one non-limiting example of a portable pressure vessel apparatus;

FIG. 2 is a further diagrammatic perspective view of the example portable pressure vessel apparatus of FIG. 1;

FIG. 3 is a further diagrammatic perspective view of the example portable pressure vessel apparatus of FIG. 1;

FIG. 4 is a further diagrammatic perspective view of the example portable pressure vessel apparatus of FIG. 1;

FIG. 5 is a diagrammatic front view of the example portable pressure vessel apparatus of FIG. 1;

FIG. 6 is a diagrammatic rear view of the example portable pressure vessel apparatus of FIG. 1;

FIG. 7 is a diagrammatic left side view of the example portable pressure vessel apparatus of FIG. 1;

FIG. 8 is a diagrammatic top view of the example portable pressure vessel apparatus of FIG. 1;

FIG. 9 is a diagrammatic bottom view of the example portable pressure vessel apparatus of FIG. 1;

FIG. 10 is a diagrammatic cross-sectional view taken across lines 10-10 in FIG. 8, wherein example valve, gauge and discharge components are shown installed in communication with the fluid chamber, and wherein the longitudinal axis is shown perpendicular to the local horizontal surface;

FIG. 11 is a diagrammatic cross-sectional view similar to that of FIG. 10, but wherein the longitudinal axis is shown parallel to the local horizontal surface;

FIG. 12 is a further diagrammatic perspective view of the example portable pressure vessel apparatus of FIG. 1, but wherein the handle is shown in an extended position;

FIG. 13 is a further diagrammatic perspective view of the example portable pressure vessel apparatus of FIG. 12;

FIG. 14 is a diagrammatic side view of the example portable pressure vessel apparatus of FIG. 12, wherein the wheels and the forward tilt stabilizer are shown collectively stably supporting the cylinder body on a local horizontal surface with the longitudinal axis maintained perpendicularly to the local horizontal surface;

FIG. 15 is a further diagrammatic side view similar to that of FIG. 14, but wherein the apparatus is shown rotated backwards to remove the forward tilt stabilizer from contact with the local horizontal surface to allow the apparatus to be transported on its wheels;

FIG. 16 is an exploded partial view of a portable pressure vessel apparatus, showing separated components of an example collar subassembly;

FIG. 17 is an exploded view of a portable pressure vessel apparatus, showing removal of components of an example undercarriage subassembly;

FIG. 18 is a diagrammatic perspective view of an example portable pressure vessel apparatus, wherein the forward tilt stabilizer has been removed from the foot portion, and the wheels have been removed from the wheel mount brackets;

FIG. 19 is a diagrammatic side view of the example portable pressure vessel apparatus of FIG. 18, wherein the foot portion is shown stably supporting the cylinder body on a local horizontal surface with the longitudinal axis maintained perpendicularly to the local horizontal surface;

FIG. 20 is a diagrammatic front view of the example portable pressure vessel apparatus of FIG. 19;

FIG. 21 is a diagrammatic side view of the example portable pressure vessel apparatus of FIG. 18, but wherein the apparatus is shown in the process of being stably mounted to a local vertical surface by way of mounting hooks and keyhole mounting elements;

FIG. 22 is a diagrammatic side view similar to that of FIG. 21, but wherein the apparatus is shown stably mounted to a local vertical surface by way of mounting hooks engaging auxiliary mounting apertures in a collar bracket, and keyhole mounting elements engaging keyhole slots in the rear face of the foot mounting brackets;

FIG. 23 is a diagrammatic side view similar to that of FIG. 22, but wherein the apparatus is shown stably mounted to a local horizonal surface by way of mounting hooks engaging auxiliary mounting apertures in a collar bracket, and keyhole mounting elements engaging keyhole slots in the rear face of the foot mounting brackets;

FIG. 24 is a diagrammatic top view of an example portable pressure vessel apparatus, wherein example valve, gauge and discharge components are shown secured to the top dome by way of respective spuds;

FIG. 25 is a diagrammatic partial side view of a further example portable pressure vessel apparatus, showing an alternate example undercarriage subassembly;

FIG. 26 is a diagrammatic partial perspective view of the example portable pressure vessel apparatus of FIG. 25;

FIG. 27 is an exploded view of the portable pressure vessel apparatus of FIG. 25, showing removal of components of the alternate example undercarriage subassembly;

FIG. 28 is a diagrammatic partial side view similar to that of FIG. 25, but wherein the forward tilt stabilizer has been removed from the foot portion, and the wheels have been removed from the wheel mount brackets;

FIG. 29 is a diagrammatic partial perspective view of the example portable pressure vessel apparatus of FIG. 28;

FIG. 29 is a diagrammatic partial perspective view of the example portable pressure vessel apparatus of FIG. 28;

FIG. 30 is a diagrammatic side view of an example portable pressure vessel apparatus, wherein the apparatus is shown stably supporting a gas appliance attached thereto;

FIG. 31 is a diagrammatic side of an alternately-configured example portable pressure vessel apparatus, wherein the apparatus is shown stably supporting a gas appliance attached thereto; and

FIG. 32 is a diagrammatic perspective of an example portable pressure vessel apparatus without an extendable handle.

### DETAILED DESCRIPTION OF THE PREFERRED EMBODIMENTS

Referring now to the drawings, like reference numerals designate identical or corresponding features throughout the several views.

Certain example embodiments of a portable pressure vessel apparatus are shown generally at 100.

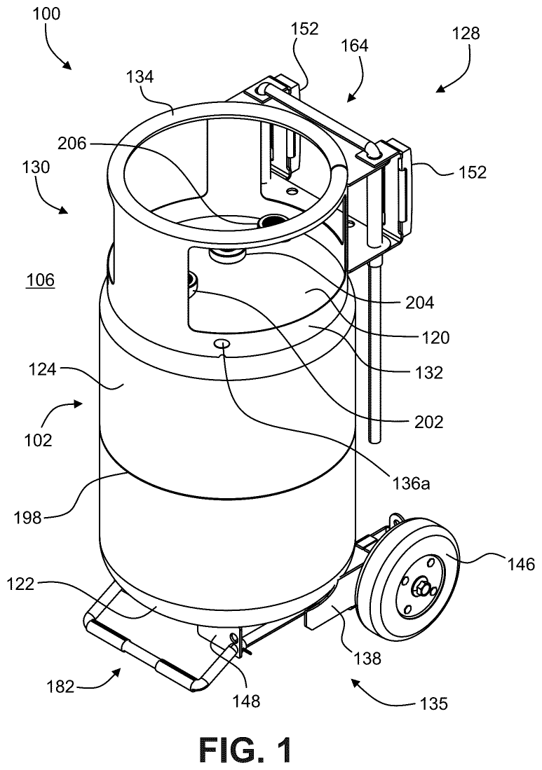

Referring to FIG. 1, a portable pressure vessel apparatus 100 may comprise a cylinder body 102, and undercarriage subassembly 135 and a collar subassembly 128.

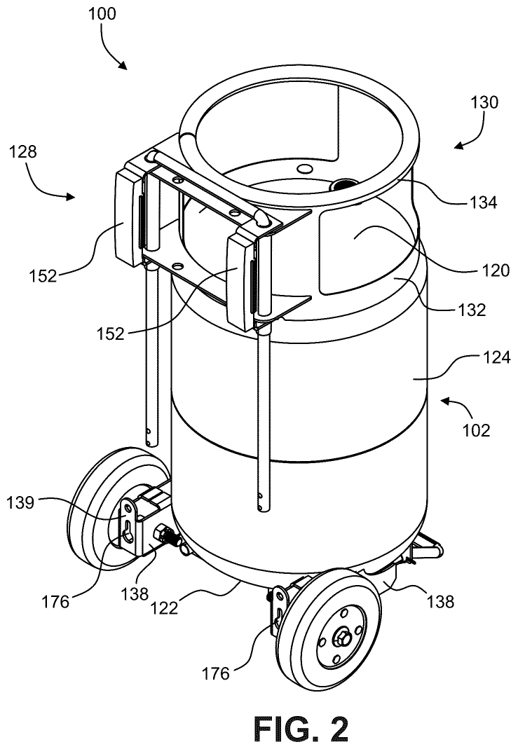

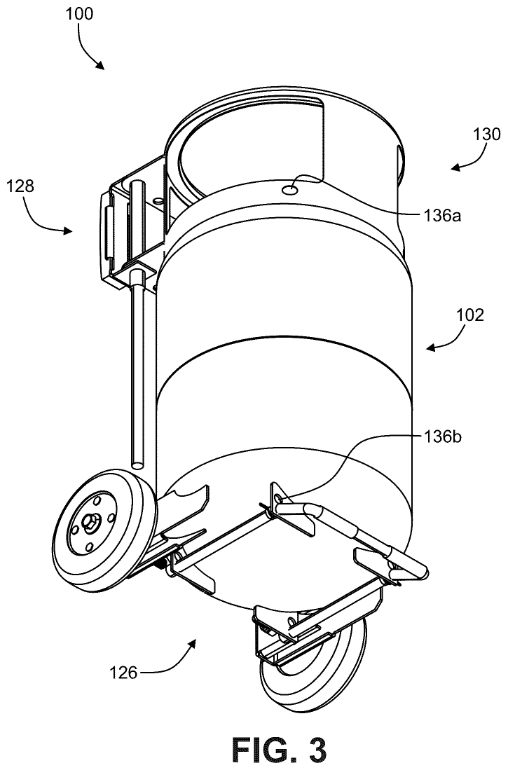

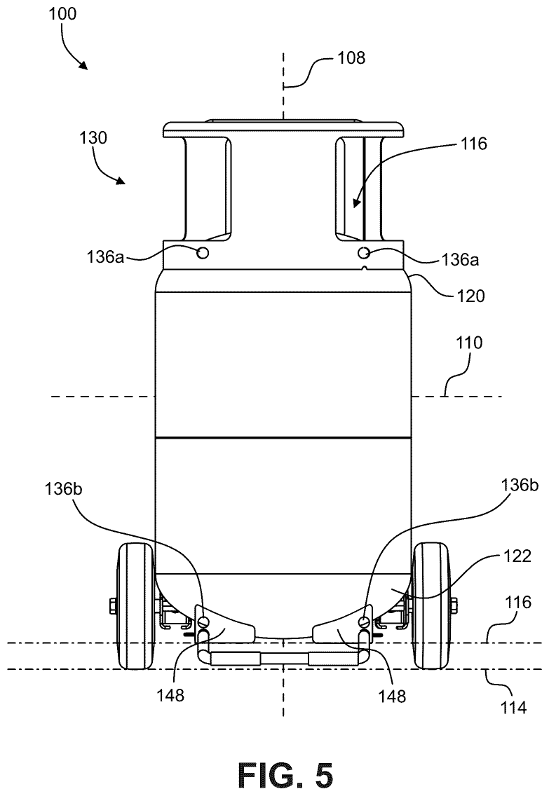

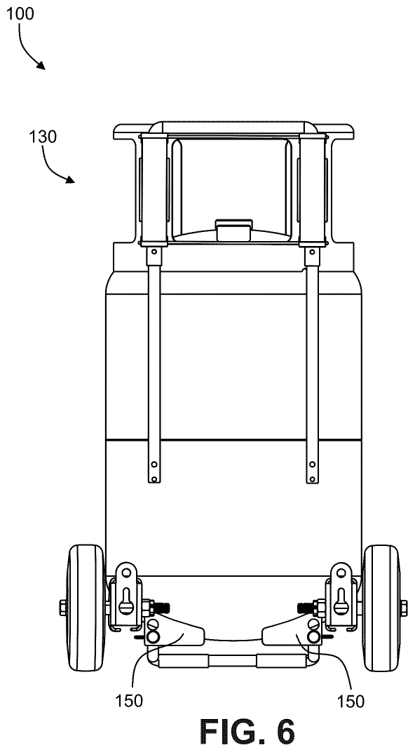

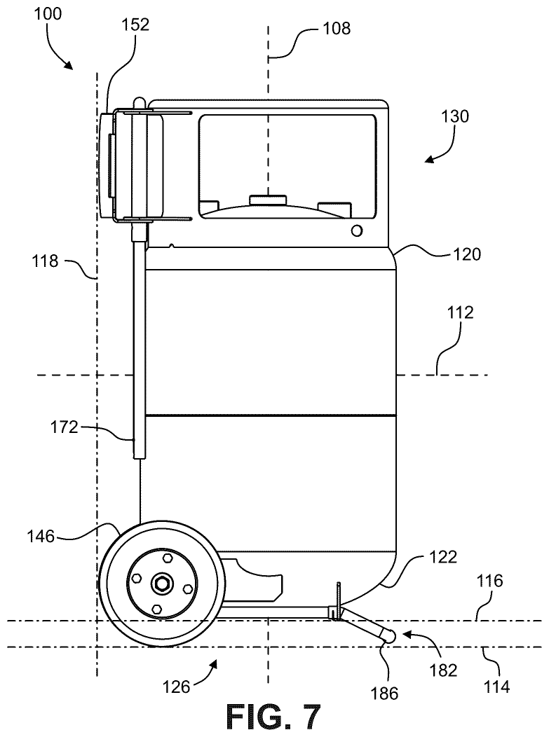

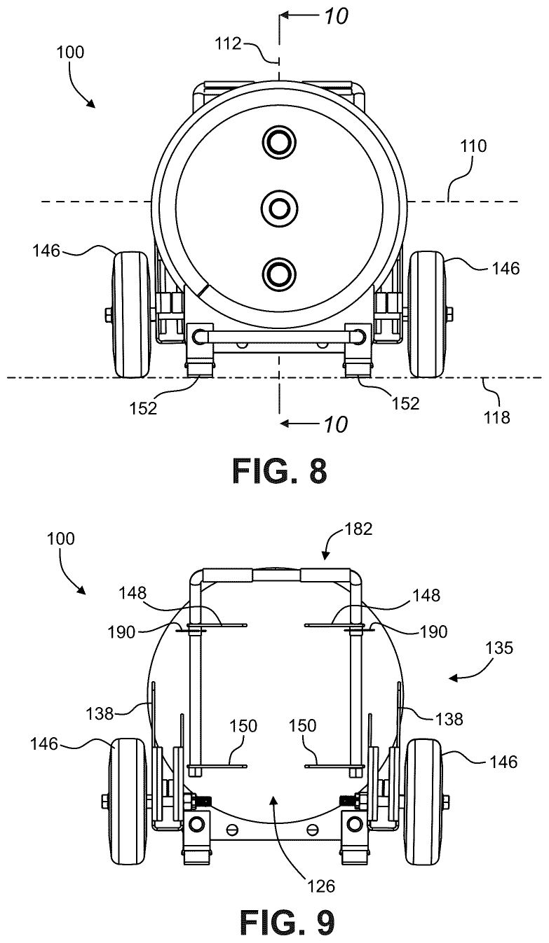

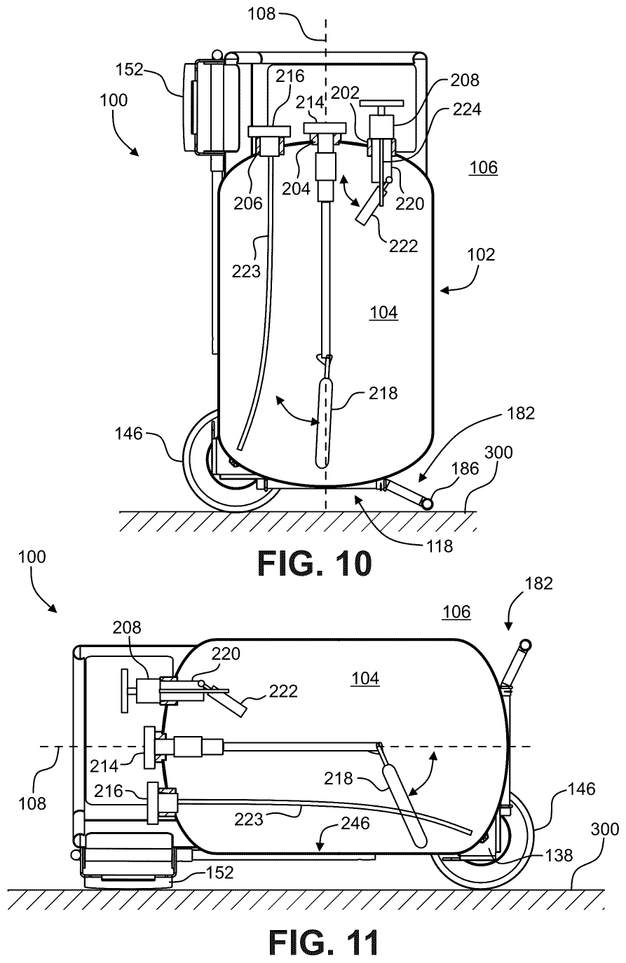

Referring to FIG. 10, the cylinder body 102 may define a pressurizable fluid chamber 104 therewithin. In certain implementations of the apparatus 100, the pressurizable fluid may preferably be, for example, propane or the like. The fluid chamber 104 may be pressurizable with respect to the ambient environment 106 external to the cylinder body 102. Referring to FIGS. 1 and 2, the cylinder body 102 may include a bottom dome 122, a top dome 120 and a radial wall 124 therebetween. Referring to FIGS. 5 and 7, a longitudinal axis 108 may be defined as extending from the bottom dome 122 through the top dome 120.

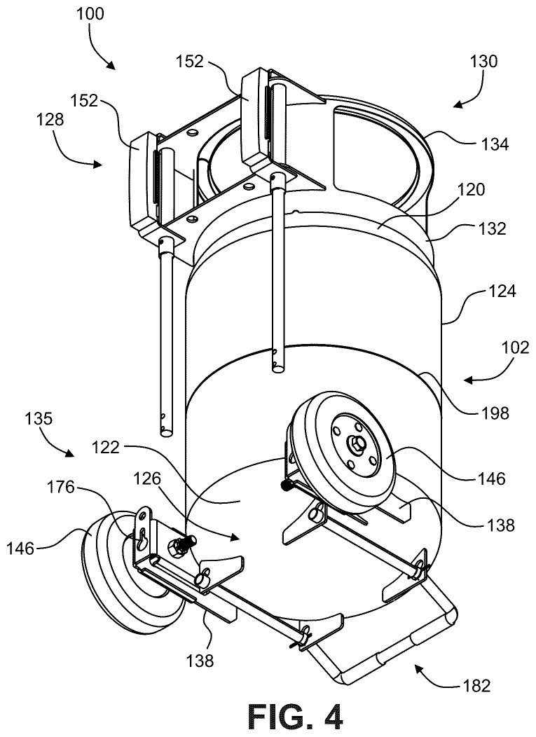

Referring to FIGS. 4 and 9, the undercarriage subassembly 135 may be attached to the bottom dome 122, and may include a foot portion 126, one or more wheel mount brackets 138, and two wheels 146. In preferred implementation of a portable pressure vessel apparatus 100, the undercarriage subassembly 135 may further include a forward tilt stabilizer 182.

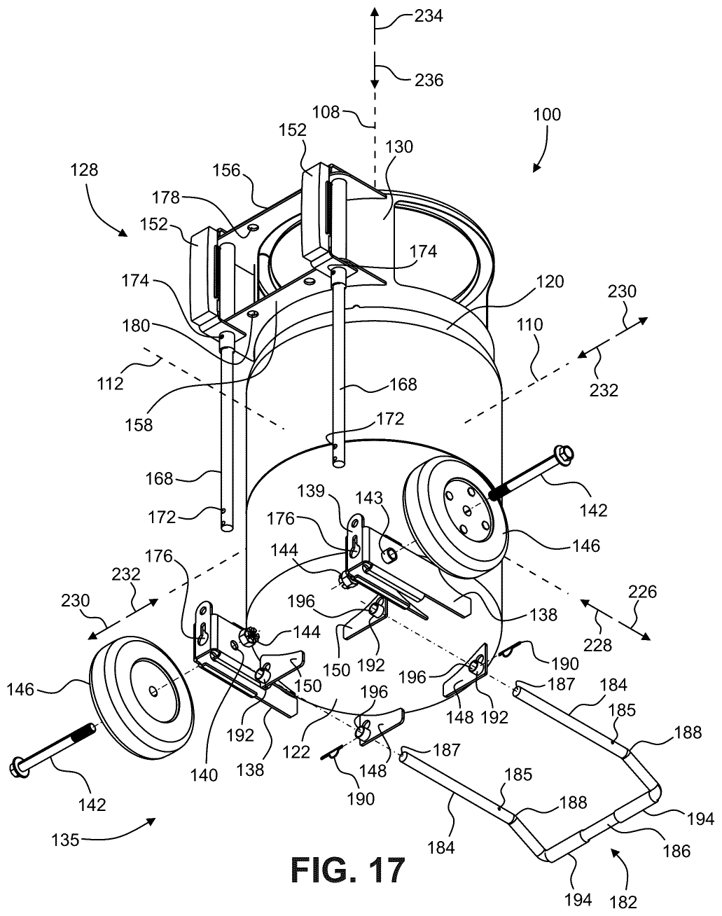

Referring to FIGS. 1 and 17, the collar subassembly 128 may be attached to the top dome 120. The collar subassembly 128 may include a collar 130, one or more rear support feet 152, and one or more collar brackets (156, 158).

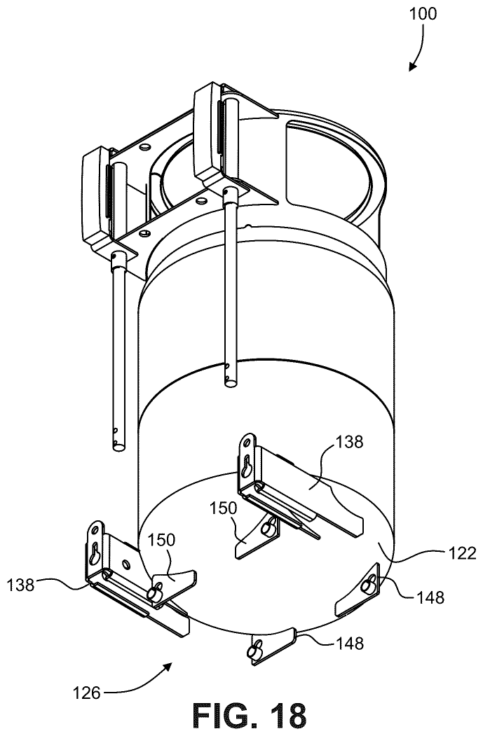

Referring to FIGS. 17 and 18, the foot portion 126 and the one or more wheel mount brackets 138 may preferably be affixed to the bottom dome 122, such as by way of welding or the like. Referring to FIGS. 4 and 17, the wheels 146 may be removably mountable to the one or more wheel brackets 138. The forward tilt stabilizer 182 may be removably securable to the foot portion 126.

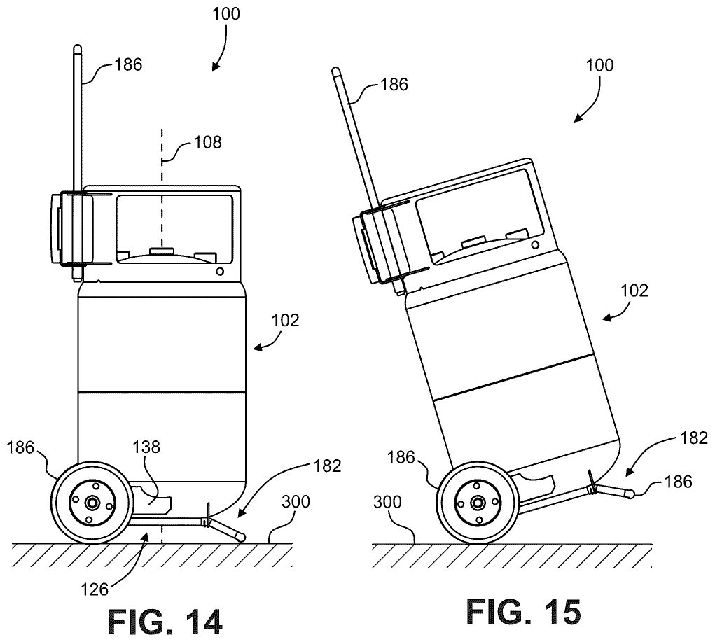

Referring to FIG. 14, the wheels 146 and the forward tilt stabilizer 182 may be configured to collectively stably support the cylinder body 102 on a local horizontal surface 300 with the longitudinal axis 108 maintained perpendicularly to the local horizontal surface 300 when (i) the wheels 146 are mounted to the one or more wheel mount brackets 138, and (ii) the forward tilt stabilizer 182 is secured to the foot portion 126.

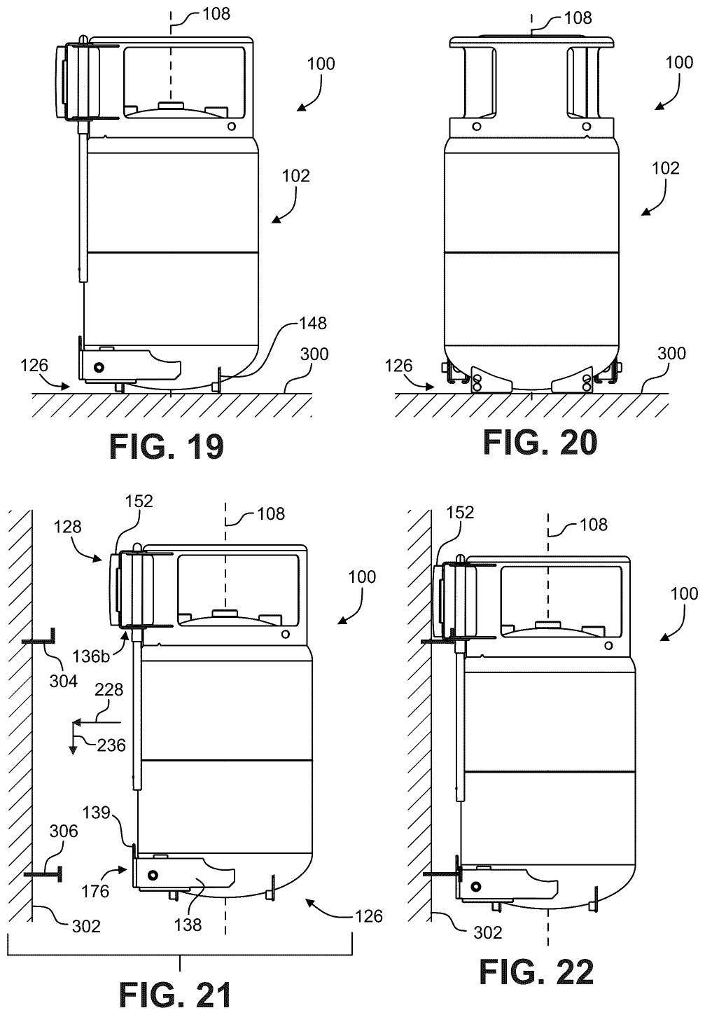

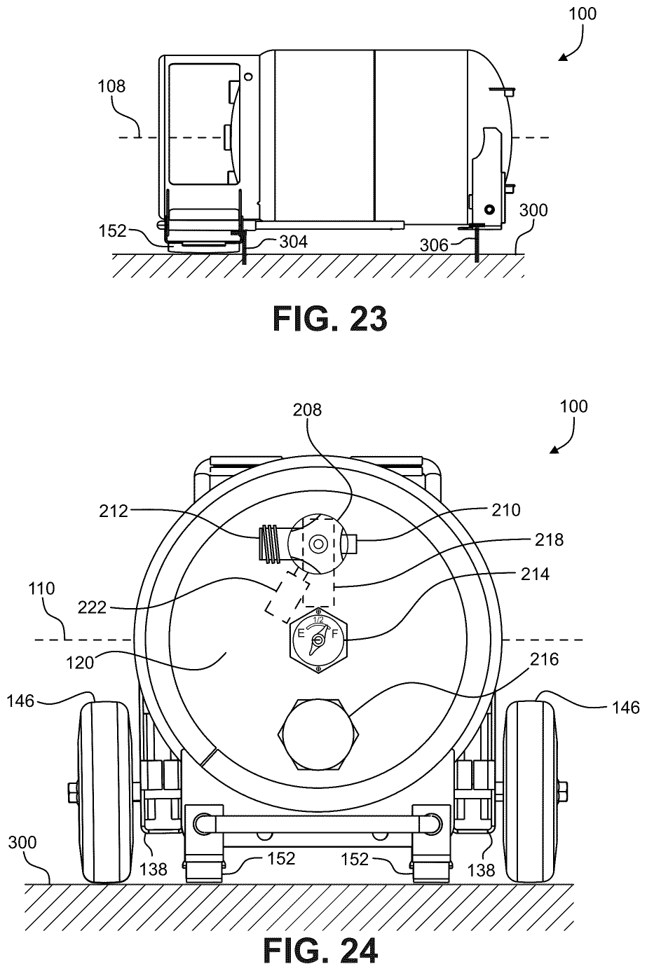

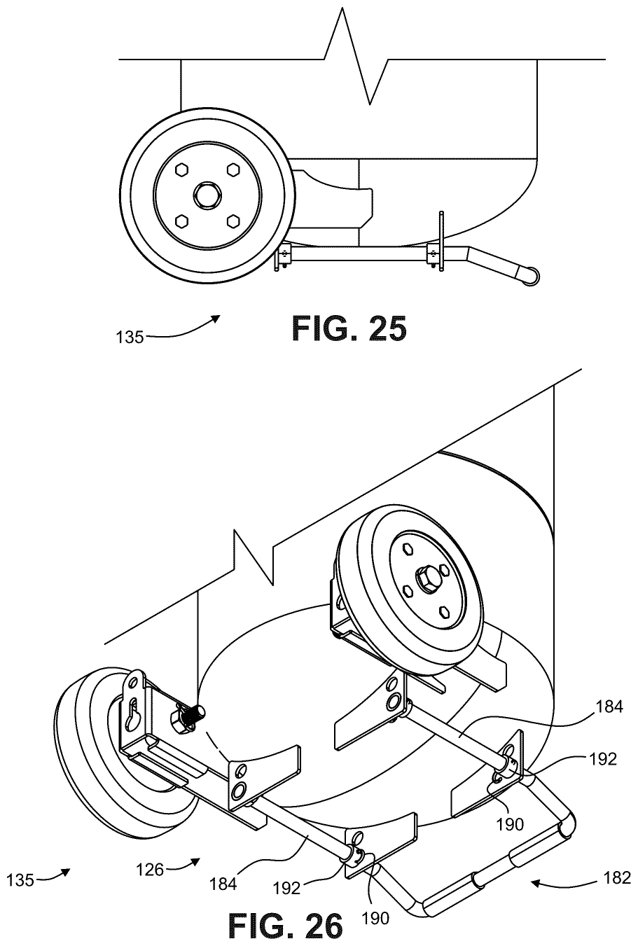

Referring to FIGS. 19 and 20, the foot portion 126 is configured to stably support the cylinder body 102 on a local horizontal surface 300 with the longitudinal axis 108 maintained perpendicularly to the local horizontal surface 300 when (i) the forward tilt stabilizer 182 is removed from the foot portion 126, and (ii) the wheels 146 are removed from the one or more wheel mount brackets 138.

Referring to FIGS. 5 and 7, in certain preferred implementations of the portable pressure vessel apparatus 100, a transverse axis 110 may be defined perpendicularly to the longitudinal axis 108, and a sagittal axis 112 may be defined orthogonally to both the longitudinal axis 108 and the transverse axis 110. Referring to FIGS. 11 and 24, the one or more rear support feet 152 and the wheels 146 may be configured to collectively stably support the cylinder body 102 on a local horizontal surface 300 with the longitudinal axis 108 and transverse axis 110 maintained parallel to the local horizontal surface 300 when the wheels 146 are mounted to the one or more wheel mount brackets 138.

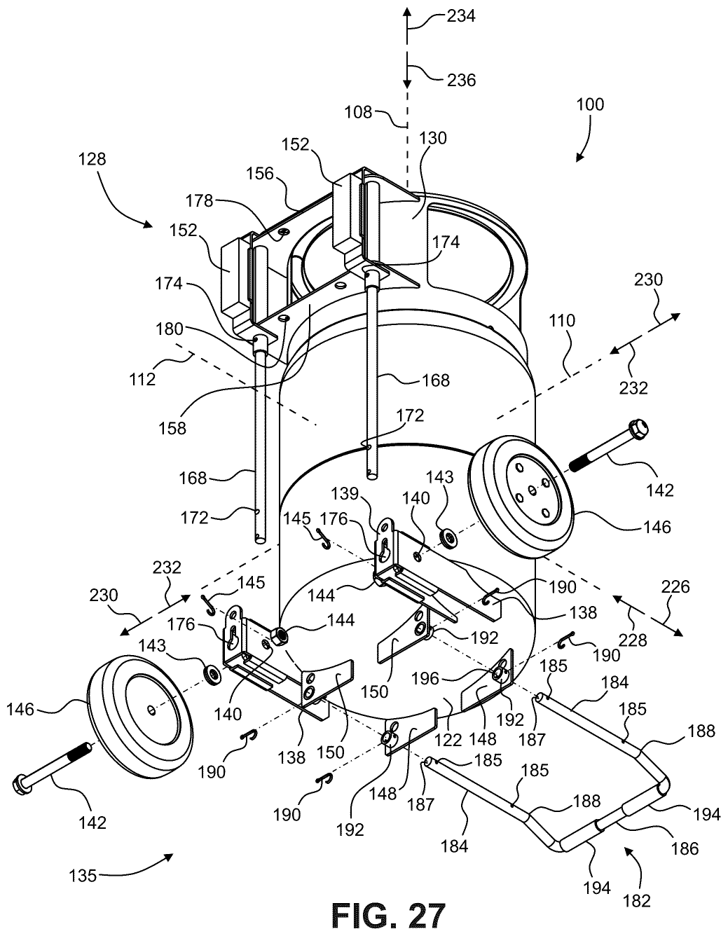

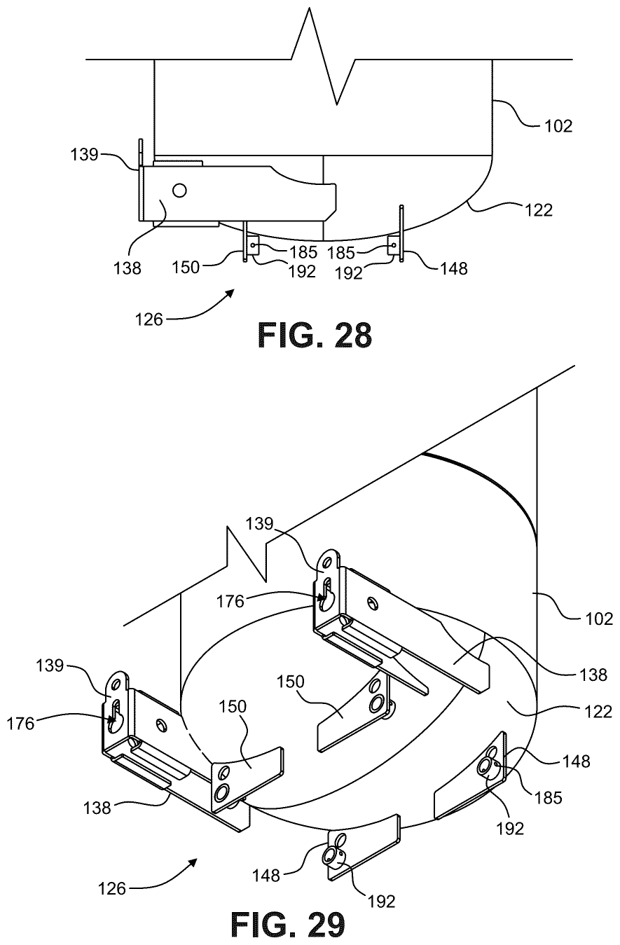

Referring to FIGS. 17 and 27, in particular preferred implementations of a portable pressure vessel apparatus 100, the forward tilt stabilizer 182 may include a pair of stabilizer guide rods 184. Moreover, the foot portion 126 may include mounting apertures 196. Referring to FIGS. 26 and 27, each stabilizer mounting aperture 196 may be configured to be in receipt of a respective one of the stabilizer guide rods 184 when the forward tilt stabilizer 182 is removably secured to the foot portion 126. Stabilizer guide tubes 192 may also be provided.

Referring to FIGS. 26 and 27, in certain preferred implementation of a portable pressure vessel apparatus 100, the removable securement of the forward tilt stabilizer 182 may be by way of one or more releasable stabilizer fasteners 190. A releasable stabilizer fastener 190 may preferably be, for example, a readily-removable fastening device like a lock pin, cotter pin, or the like. Stabilizer guide tubes 192 may be provided to provide facilitate secure alignment and engagement between the stabilizer guide rods 184, stabilizer fasteners 190 and the foot portion 126. Moreover, stabilizer lock pin apertures 185 may extend through the stabilizer guide rods 184, to receive a releasable stabilizer fastener 190 extending through a respective stabilizer guide tube 192. A stabilizer cross bar 186 may extend, for example, between the stabilizer guide rods 184. The stabilizer guide rods 184 may each preferably include a stabilizer elbow 188, in order to position the stabilizer cross bar 186 below foot segments (148, 150).

Referring to FIG. 29, the foot portion 126 may be comprised of multiple foot segments (148. 150). For example, one or more forward foot segments 148 and one or more rear foot segments 150 may be provided. These foot segments may preferably be affixed to the bottom dome 122 permanently by way of, for example, welding or the like. As illustrated for example in FIG. 29, the multiple foot segments (148, 150) may preferably be flat planar.

Referring to FIGS. 9 and 27, in particular implementations of a portable pressure vessel apparatus 100, the undercarriage subassembly 135 may include two wheel mount brackets 138. In such case, each of the wheels 146 may be removably mounted to a respective one of the wheel mount brackets 138. For example, referring to FIGS. 17 and 27, each wheel 146 may be removably mounted to a respective wheel mount bracket 138 by way of a wheel mount axle 142 (e.g., a threaded bolt or the like) extending through the wheel 146 and a wheel mount aperture 140 in the wheel mount bracket 138. The wheel mount axles 142 may be secured in place by way of, for example, wheel mount nut 144 or the equivalent. An axle securement pin 145 (e.g., cotter pin) may be provided as an added safety measure to prevent the nut 144 from undesirable self-unthreading and releasing the wheel mount axle 142. Wheel spacers 143, such as one or more washers, may also be provided to maintain proper spacing between the wheel 146 and the outboard face of the adjacent wheel mount bracket 138.

Referring to FIGS. 17 and 27, a rear face 139 of each of the wheel mount brackets 138 may include a keyhole slot 176 extending therethrough. The one or more collar brackets (156, 158) may include one or more hook engagement apertures (178, 180). For example, an upper collar bracket 156 may include one or more upper hook engagement apertures 178, and a lower collar bracket 158 may include one or more lower hook engagement apertures 180. Referring to FIGS. 21 and 22, the keyhole slots 176 and hook engagement apertures (e.g., 136b) may be used to support the mounting of the apparatus 100 to a local vertical surface 302 (such as a wall) by way of mounting hooks 304 and keyhole mounting elements 306 (such as wall-mounted screws or the like).

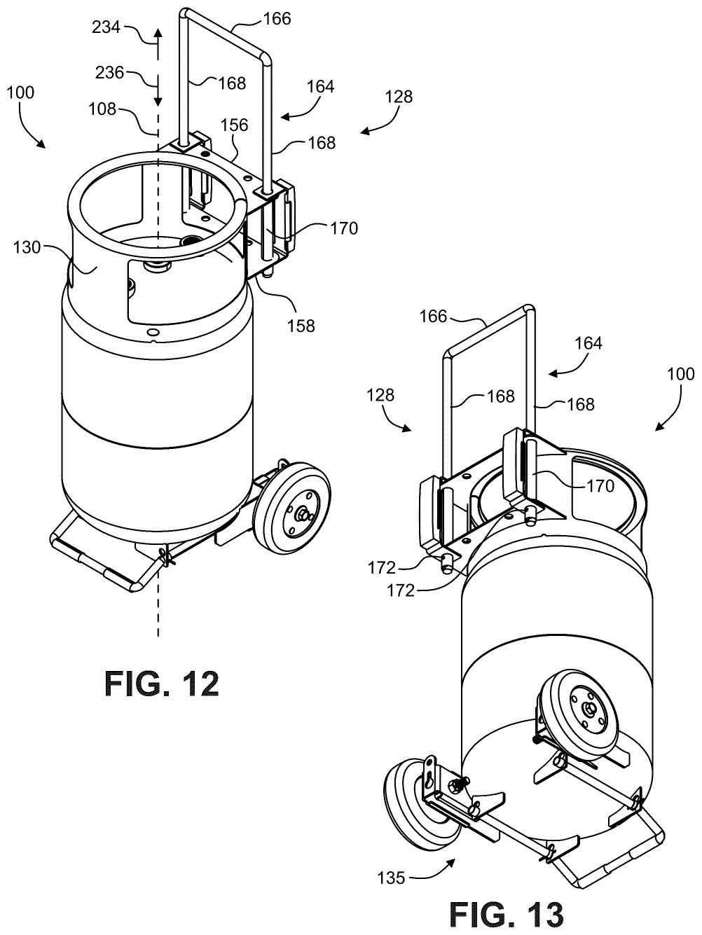

Referring to FIGS. 12 and 17, in certain preferred implementations of a portable pressure vessel apparatus 100, the one or more collar brackets (156, 158) may be configured to mount a handle 164 to the collar 130 and enable guided movement of the handle 164 between an extended position (shown, for example in FIG. 12) and a retracted position (shown, for example, in FIG. 1) with respect to the collar 130.

Referring to FIG. 1, in certain preferred implementations of a portable pressure vessel apparatus 100, the collar 130 may include a collar base portion 132 and a collar grip portion 134.

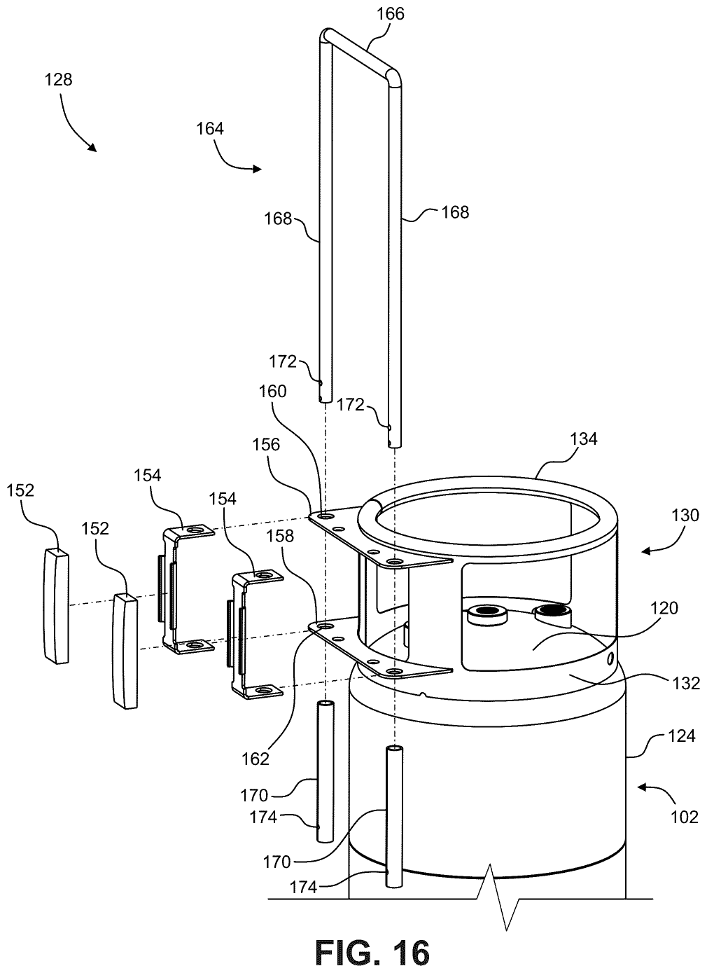

Referring to FIGS. 16 and 17, in particular preferred implementations of a portable pressure vessel apparatus 100, the one or more collar brackets include an upper collar bracket 156 and a lower collar bracket 158. In such cases, two rear support feet 152 may each be mounted to the upper collar bracket 156 and the lower collar bracket 158. The collar subassembly 128 may include a pair of rear foot brackets 154. Each of the rear support feet 152 may be simultaneously mounted to the upper collar bracket 156 and the lower collar 158 bracket by way of a respective one of the rear foot brackets 154.

Referring again to FIGS. 16 and 17, in certain preferred implementations of a portable pressure vessel apparatus 100, the collar subassembly 128 may include a pair of handle guide tubes 170. Each handle guide tube 170 may be affixed to the upper collar bracket 156 and the lower collar bracket 158, for example by way of welding or other method. Upper guide tube apertures 160 may be provided in the upper collar bracket 156, and lower guide tube apertures 162 may be provided in the lower collar bracket 158. The upper and lower guide tube apertures (160, 162) may be configured to receive respective handle guide tubes 170. In certain implementations of the apparatus 100, weld joints may preferably be formed where the handle guide tubes 170 engage the respective guide tuber apertures (160, 162). The handle 164 may have a pair of handle guide rods 168. Each handle guide tube 170 may be in slidable receipt of a respective one of the handle guide rods 168 to facilitate said guided movement of the handle 164. The handle 164 may preferably have a grip portion 166 disposed, for example, between a pair of handle guide rods 168.

Referring again to FIGS. 16 and 17, in particular preferred implementations of a portable pressure vessel apparatus 100, each handle guide rod 168 may have a handle extension detent 172 (e.g., a spring ball detent or the like) configured to releasably engage a detent interface 174 of the respective handle guide tube 170. This releasable engagement may be configured, for example, to hinder movement of the handle 164 from the extended position. This releasable engagement is preferably configured to be overcome manually by a user of the apparatus, for example by pressing in on the spring ball detent.

In certain preferred implementations of a portable pressure vessel apparatus 100, the rear support feet 152 may be comprised of an elastomer, such as rubber or the like.

Referring to FIGS. 1 and 10, certain preferred implementations of a portable pressure vessel apparatus 100 may further comprise, in the top dome 120, a service valve spud 202, a level gauge spud 204, and possibly a liquid discharge spud 206. The service valve spud 202 may be configured for use in securing a service valve 208 in fluid communication with the fluid chamber 104. A level gauge spud 204 may be configured to secure a level gauge 214 in fluid communication with the fluid chamber 104. A liquid discharge spud 206 may be configured to secure a liquid discharge tube 223 in fluid communication with the fluid chamber 104. A plug 216 may be provided to prevent fluid from being discharged from the fluid chamber 104 through the liquid discharge tube 223 until such liquid discharge is desired. In particular implementations of a portable pressure vessel apparatus 100, an overfill protection device 220 with a service float 222 may be disposed in fluid communication between the service valve 208 and the fluid chamber 104. Alternatively, or in addition, the level gauge 214 may be controlled by a gauge float 218. Referring to FIG. 11, the gauge float 218 may preferably have a range of moveability enabling it to contact a rear wall 246 of the fluid chamber 104. The service valve 208 may preferably include an overfill dip tube 224, a pressure relief port 210, and a vapor discharge outlet 212.

In certain preferred implementations of a portable pressure vessel apparatus 100, the foot portion 126 and the one or more wheel mount brackets 138 may be welded to the bottom dome 122, the collar 130 may be welded to the top dome 120, and the collar brackets (156, 158) may be welded to the collar 130.

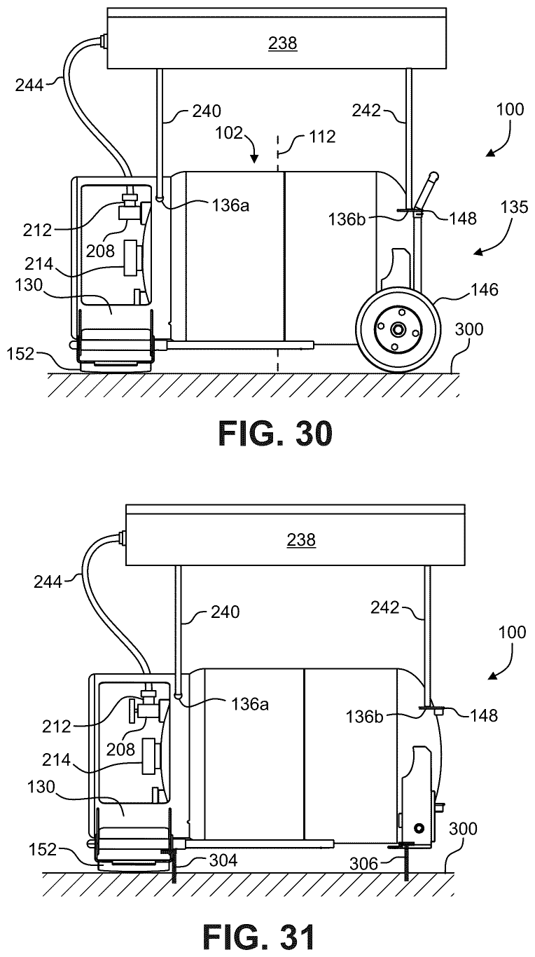

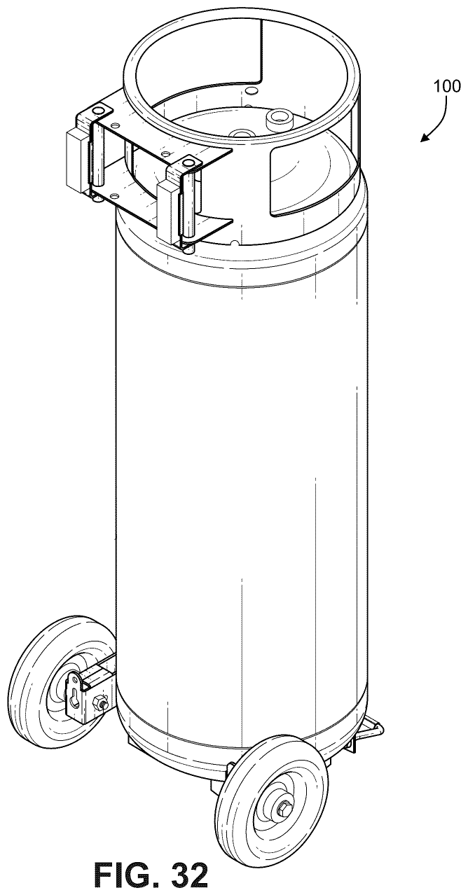

Referring to FIGS. 11 and 30, particular preferred implementations of a portable pressure vessel apparatus 100 comprise a service valve 208 configured to supply fuel (e.g., propane) from the fluid chamber 104 to a gas appliance 238 (e.g., a barbeque grill). Referring to FIGS. 5 and 11, in such implementations, the collar 130 may include one or more upper auxiliary mounting apertures 136a, and the foot portion 126 may include one or more lower auxiliary mounting apertures 136b. Referring to FIGS. 11 and 30, in such implementations, the upper and lower auxiliary mounting apertures (136a, 136b) may be configured to be engaged by the gas appliance 238 for enabling the portable pressure vessel apparatus 100 to stably support the gas appliance 238 when the cylinder body 102 is stably supported on a local horizontal surface 300 with the longitudinal axis 108 and the transverse axis 110 maintained parallel to the local horizontal surface 300 (which is the same as the sagittal axis 112 being maintained perpendicularly to the local horizontal surface). Appliance support elements 240 and 242 (e.g., support legs, support brackets, or the like) may be provided as load-bearing connective interfaces between the apparatus 100 and the remainder of the gas appliance 238 supported above the apparatus 100. A gas appliance conduit 244 (such as a gas connector hose or the like), may be provided to place the gas appliance 238 in fuel-receiving communication with the service valve 208.

The following listing matches certain terminology used within this disclosure with corresponding reference numbers used in the non-limiting examples illustrated in the several figures.
100 portable pressure vessel apparatus
102 cylinder body
104 fluid chamber
106 ambient environment
108 longitudinal axis
110 transverse axis
112 sagittal axis
114 first support plane
116 second support plane
118 third support plane
120 top dome
122 bottom dome
124 radial wall
126 foot portion
128 collar subassembly
130 collar (e.g., shroud/protection ring/neck ring)
132 collar base portion
134 collar grip portion
135 undercarriage subassembly
136a upper auxiliary mounting aperture
136b lower auxiliary mounting aperture
138 wheel mount bracket
139 rear face (of wheel mount bracket)
140 wheel mount aperture
142 wheel mount axle (e.g. threaded bolt)
143 wheel spacer (e.g., a cylindrical sleeve, or one or more washers)
144 wheel mount nut (e.g., threadedly engageable with wheel mount axle)
145 axle securement pin
146 wheel (e.g., removable)
148 forward foot segment (of foot portion; e.g., formed of sheet metal)
150 rearward foot segment (of foot portion; e.g., formed of sheet metal)
152 rear support foot (e.g., rubber pad)
154 rear foot bracket
156 upper collar bracket (e.g., formed of sheet metal)
158 lower collar bracket (e.g., formed of sheet metal)
160 upper guide tube aperture
162 lower guide tube aperture
164 handle
166 grip portion
168 handle guide rod
170 handle guide tube
172 handle extension detent
174 detent interface (e.g., configured to engage handle extension detent)
176 keyhole slot
178 upper hook engagement aperture
180 lower hook engagement aperture
182 forward tilt stabilizer
184 stabilizer guide rod
185 stabilizer lock pin aperture
186 stabilizer cross bar
187 free end (of stabilizer guide rod)
188 stabilizer elbow
190 releasable stabilizer fastener (e.g., lock pin, cotter pin, etc.)
192 stabilizer guide tube
194 stabilizer pad (e.g., cylindrical rubber pad on stabilizer cross bar)
196 stabilizer mounting aperture (e.g., in forward and rearward support feet)
198 circumferential weld
200 longitudinal weld
202 service valve spud
204 level gauge spud
206 liquid discharge spud
208 service valve (e.g., ¾″-14 NPT)
210 relief
212 outlet
214 level gauge (e.g., ¾″-14 NPT)
216 plug (e.g., ¾″-14 NPT) (e.g., to drain tank of liquid propane)
218 gauge float (for driving fuel level gauge)
220 overfill protection device (e.g., OPD valve)
222 service float (for driving OPD valve)
223 liquid discharge tube
224 overfill dip tube
226 forward direction
228 rearward direction
230 laterally outward direction
232 laterally inward direction
234 upward direction
236 downward direction
238 gas appliance (e.g., barbecue grill)
240 appliance support element (e.g., support leg or support bracket)
242 appliance support element (e.g., support leg or support bracket)
244 gas appliance conduit (e.g., gas connector hose)
246 rear wall (of fluid chamber)
300 local horizontal surface (e.g., a floor or ground surface)
302 local vertical surface (e.g., a wall)
304 mounting hook (e.g., wall-mounted hook)
306 keyhole mounting element (e.g., wall-mounted screw)

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A portable pressure vessel apparatus comprising:
a cylinder body defining a pressurizable fluid chamber therewithin, the cylinder body including a bottom dome and a top dome, a longitudinal axis being defined as extending from the bottom dome through the top dome;
an undercarriage subassembly attachable to the bottom dome, and including a foot portion, one or more wheel mount brackets, two wheels, and a forward tilt stabilizer; and
a collar subassembly attached to the top dome, and including a collar, one or more rear support feet, and one or more collar brackets;
wherein
(a) the foot portion and the one or more wheel mount brackets are affixed to the bottom dome,
(b) the wheels are removably mountable to the one or more wheel mount brackets,
(c) the forward tilt stabilizer is removably securable to the foot portion,
(d) the wheels and the forward tilt stabilizer are configured to collectively stably support the cylinder body on a local horizontal surface with the longitudinal axis maintained perpendicularly to the local horizontal surface when
(i) the wheels are mounted to the one or more wheel mount brackets, and
(ii) the forward tilt stabilizer is secured to the foot portion, and
(e) the foot portion is configured to stably support the cylinder body on a local horizontal surface with the longitudinal axis maintained perpendicularly to the local horizontal surface when
(i) the forward tilt stabilizer is removed from the foot portion, and
(ii) the wheels are removed from the one or more wheel mount brackets.

2. The portable pressure vessel apparatus of claim 1, wherein
(a) a transverse axis is defined perpendicularly to the longitudinal axis, and
(b) the one or more rear support feet and the wheels are configured to collectively stably support the cylinder body on a local horizontal surface with the longitudinal axis and transverse axis maintained parallel to the local horizontal surface when the wheels are mounted to the one or more wheel mount brackets.

3. The portable pressure vessel apparatus of claim 2, wherein
(a) the forward tilt stabilizer includes a pair of stabilizer guide rods,
(b) the foot portion includes stabilizer mounting apertures, and
(c) each stabilizer mounting aperture is configured to be in receipt of a respective one of the stabilizer guide rods when the forward tilt stabilizer is removably secured to the foot portion.

4. The portable pressure vessel apparatus of claim 3, wherein the removable securement of the forward tilt stabilizer is by way of one or more releasable stabilizer fasteners.

5. The portable pressure vessel apparatus of claim 4, wherein the foot portion is comprised of multiple foot segments.

6. The portable pressure vessel apparatus of claim 5, wherein the multiple foot segments are flat planar.

7. The portable pressure vessel apparatus of claim 5, wherein
(a) the undercarriage subassembly includes two said wheel mount brackets,
(b) each of the wheels is removably mounted to a respective one of the wheel mount brackets, and
(c) a rear face of each of the wheel mount brackets includes a keyhole slot extending therethrough.

8. The portable pressure vessel apparatus of claim 7, wherein the one or more collar brackets include one or more hook engagement apertures.

9. The portable pressure vessel apparatus of claim 1, wherein the one or more collar brackets are configured to mount a handle to the collar and enable guided movement of the handle between an extended position and a retracted position with respect to the collar.

10. The portable pressure vessel apparatus of claim 9, wherein
(a) the one or more collar brackets include an upper collar bracket and a lower collar bracket, and
(b) two rear support feet are each mounted to the upper collar bracket and the lower collar bracket.

11. The portable pressure vessel apparatus of claim 10, wherein the rear support feet are comprised of an elastomer.

12. The portable pressure vessel apparatus of claim 11, wherein
(a) the collar subassembly includes a pair of rear foot brackets, and
(b) each of the rear support feet are simultaneously mounted to the upper collar bracket and the lower collar bracket by way of a respective one of the rear foot brackets.

13. The portable pressure vessel apparatus of claim 12, wherein
(a) the collar subassembly includes
(i) a pair of handle guide tubes, each handle guide tube being affixed to the upper collar bracket and the lower collar bracket, and
(ii) a handle having a pair of handle guide rods, and
(b) each handle guide tube is in slidable receipt of a respective one of the handle guide rods to facilitate said guided movement of the handle.

14. The portable pressure vessel apparatus of claim 13, wherein each handle guide rod has a handle extension detent configured to releasably engage a detent interface of the respective handle guide tube, the releasable engagement being configured to hinder movement of the handle from the extended position.

15. The portable pressure vessel apparatus of claim 1, further comprising in the top dome
(a) a service valve spud by which a service valve is securable in fluid communication with the fluid chamber;
(b) a level gauge spud by which a level gauge is securable in fluid communication with the fluid chamber; and
(c) a liquid discharge spud by which a liquid discharge tube is securable in fluid communication with the fluid chamber.

16. The portable pressure vessel apparatus of claim 15, further comprising
(a) a service valve in fluid communication with the fluid chamber;
(b) a level gauge in fluid communication with the fluid chamber; and
(c) a liquid discharge tube in fluid communication with the fluid chamber.

17. The portable pressure vessel apparatus of claim 16, wherein
(a) an overfill protection device is disposed in fluid communication between the service valve and the fluid chamber; and
(b) the level gauge is controlled by a gauge float, the gauge float having a range of moveability enabling it to contact a rear wall of the fluid chamber.

18. The portable pressure vessel apparatus of claim 1, wherein
(a) the foot portion and the one or more wheel mount brackets are welded to the bottom dome,
(b) the collar is welded to the top dome, and
(c) the collar brackets are welded to the collar.

19. The portable pressure vessel apparatus of claim 2, wherein
(a) the portable pressure vessel apparatus comprises a service valve configured to supply fuel from the fluid chamber to a gas appliance,
(b) the collar includes one or more upper auxiliary mounting apertures,
(c) the foot portion includes one or more lower auxiliary mounting apertures, and
(d) the upper and lower auxiliary mounting apertures are configured to be engaged by the gas appliance for enabling the portable pressure vessel apparatus to stably support the gas appliance when the cylinder body is stably supported on a local horizontal surface with the longitudinal axis and the transverse axis maintained parallel to the local horizontal surface.

20. A portable pressure vessel apparatus comprising:
a cylinder body defining a pressurizable fluid chamber therewithin, the cylinder body including a bottom dome and a top dome, a longitudinal axis being defined as extending from the bottom dome through the top dome;
an undercarriage subassembly attachable to the bottom dome, and including a foot portion, one or more wheel mount brackets, two wheels, and a forward tilt stabilizer; and
a collar subassembly attached to the top dome, and including a collar, one or more rear support feet, and one or more collar brackets;
wherein
(a) the foot portion and the one or more wheel mount brackets are affixed to the bottom dome,
(b) the wheels are removably mountable to the one or more wheel mount brackets,
(c) the forward tilt stabilizer is removably securable to the foot portion,
(d) the wheels and the forward tilt stabilizer are configured to collectively stably support the cylinder body on a local horizontal surface with the longitudinal axis maintained perpendicularly to the local horizontal surface when
(i) the wheels are mounted to the one or more wheel mount brackets, and
(ii) the forward tilt stabilizer is secured to the foot portion,
(e) the foot portion is configured to stably support the cylinder body on a local horizontal surface with the longitudinal axis maintained perpendicularly to the local horizontal surface when
(i) the forward tilt stabilizer is removed from the foot portion, and
(ii) the wheels are removed from the one or more wheel mount brackets,
(f) a transverse axis is defined perpendicularly to the longitudinal axis,
(g) the one or more rear support feet and the wheels are configured to collectively stably support the cylinder body on a local horizontal surface with the longitudinal axis and transverse axis maintained parallel to the local horizontal surface when the wheels are mounted to the one or more wheel mount brackets, and
(h) the one or more collar brackets are configured to mount a handle to the collar and enable guided movement of the handle between an extended position and a retracted position with respect to the collar.
